(19) United States
(12) Patent Application Publication
(10) Pub. No.: US 2008/0226866 A1
(43) Pub. Date: Sep. 18, 2008

(54) SEALANT MATERIAL

(75) Inventors: Mark J. Vilcek, Lake Orion, MI (US); Abraham Kassa, Shelby Twp., MI (US)

Correspondence Address: DOBRUSIN & THENNISCH PC, 29 W LAWRENCE ST, SUITE 210, PONTIAC, MI, 48342, US

(73) Assignee: Zephyros, Inc., Romeo, MI (US)

(21) Appl. No.: 12/048,684

(22) Filed: Mar. 14, 2008

Related U.S. Application Data
(60) Provisional application No. 60/894,945, filed on Mar. 15, 2007.

(51) Int. Cl. B32B 3/06; B23P 25/00; B21D 35/00

(52) U.S. Cl. 428/99; 29/458; 29/469.5

(57) ABSTRACT

There is disclosed a sealant material for providing sealing to a substrate and preferably an interface. The sealant material may include a locator mechanism.

### CLAIM OF PRIORITY

To the extent applicable, the present invention claims the benefit of the priority of U.S. Provisional Application Ser. No. 60/894,945 filed Mar. 15, 2007, the contents of which are incorporated by reference herein.

### FIELD OF THE INVENTION

The present invention relates to a sealant material for sealing a component of an article of manufacture such as an automotive vehicle.

### BACKGROUND OF THE INVENTION

Sealant materials are often applied to a surface for sealing or for otherwise covering the surface, including any joints associated therewith. There presently exist a vast number of sealant materials that serve these purposes for different articles of manufacture. However, in certain circumstances, it may be desirable for sealant materials to serve other additional purposes depending on the components or articles of manufacture to which the sealant materials are applied.

For example, in some industries, such as the furniture, appliance or automotive industries, joints are often part of a show surface, and are thus visible to a user or consumer. Accordingly, one desirable characteristic for a sealant material covering a joint is to provide a generally smooth or continuous or controlled patterned surface that is cosmetically pleasing. If colorant is not already included in the sealant, but a color is desirable, preferably the sealant material is paintable or otherwise coatable.

As another example, it may be desirable for a sealant material to be compatible with other components of an article of manufacture. For instance, it may be desirable for a sealant material to provide a relatively smooth and consistent surface such that a component of an article of manufacture may be contacted with that sealant material without surface inconsistencies of the sealant material showing or reading through the component.

As yet another example, it can be desirable for the sealant material to be able to flow and seal while still at least assisting in maintaining spatial relationships between components of an article of manufacture particularly where one or more of the components are at least partially supported by the sealant material. For instance, it can be desirable for an automotive trim piece to remain relatively immobile relative to adjacent automotive components during flow of a portion of the sealant material.

Moreover, certain assembly operations in the aforenoted industries and others, require that a sealant material be heated along with the article to which it is applied. For instance, some priming or painting operations are conducted at elevated temperatures. Thus, another desirable trait for certain sealants is that they exhibit attractive temperature response characteristics for a desired application (e.g., a sealant material preferably does not exhibit random oozing, bubbling, rippling, or the like).

Examples of sealant materials including physical designs of sealant materials and formulations of sealant materials, both of which may be used in conjunction with or as part of the sealant material of the present invention, are disclosed in the following references: U.S. Pat. No. 7,208,538; U.S. Pat. No. 7,094,843; U.S. Pat. No. 7,043,815; U.S. Pat. No. 6,991,237; U.S. Pat. No. 6,858,260; U.S. Pat. No. 6,747,074; U.S. Pat. No. 6,742,258; U.S. Pat. No. 6,720,387; U.S. Pat. No. 6,656,979; U.S. Pat. No. 6,620,501; U.S. Pat. No. 6,582,824; U.S. Pat. No. 6,489,023; U.S. Pat. No. 6,485,589; U.S. Pat. No. 6,461,691; U.S. Pat. NO. 6,350,791; US 2007/0193171; US 2007/0088138; US 2006/0160932; US 2006/0127584; US 2006/0020076; US 2005/0269840; US 2005/0224173; US 2005/0221046; US 2005/0154089; US 2005/0119373; US 2004/0204551; US 2004/0197571; US 2004/0143071; US 2004/0131844; US 2004/0048060; US 2004/0033324; US 2004/0016564; US 20030140671; US 2002/0182339; WO 02/086003; WO 03/103921; WO 03/072677; WO 03/011954; WO 2004/037509; EP 0 742 814 B1; and EP 1 240 266 B1; all of which are incorporated herein by reference for all purposes.

### SUMMARY OF THE INVENTION

In a first aspect, the present invention contemplates a method for sealing a roof ditch joint in an automotive vehicle, comprising the steps of providing a sealing member that includes a polymeric melt flow layer; and a fibrous scrim layer attached to the melt flow layer; and a fastener that receives and fastens an exterior trim molding to the sealing member; positioning the sealing member in a roof ditch over a joint defined by two overlapping metal sheets; coating the sealing member and the metal sheets; heating the coated metal sheets and the sealing member in a bake oven for causing the melt flow layer to flow and spread within the roof ditch and seal the joint; attaching an exterior trim molding to the sealing member with the fastener to substantially cover the roof ditch.

This aspect may be further characterized by one or any combination of the following features: the fibrous scrim layer is a woven fibrous scrim layer, the woven fibrous scrim layer includes polyester, the fastener is an elongated clip with a base portion and flexible members that extend upward from the base and the flexible members elastically deform during fastening to a trim piece, the fastener is attached to an upper surface of the sealing member by a layer of adhesive, the sealing member consists essentially of the fibrous scrim layer and the melt flow layer and the scrim layer substantially overlays an upper surface of the melt flow layer so that the melt flow layer impregnates a portion of the scrim, the polymeric melt flow layer is free to flow throughout the roof ditch without physical constraint from a structure of the sealing member.

In another aspect, the present invention contemplates a sealing member for sealing a roof ditch comprising: an elongated substantially constant profile sealing body including a polymeric melt flow layer; and a fibrous scrim layer attached to the melt flow layer; fasteners that project away from an upper surface of the sealing body and receive an exterior trim molding.

This aspect may be further characterized by one or any combination of the following features: the fibrous scrim layer is a woven fibrous scrim layer, the woven fibrous scrim layer includes polyester, the fastener is an elongated clip with a base portion and flexible members that extend upward from the base and the flexible members elastically deform during fastening to a trim piece, the fastener is attached to an upper surface of the sealing member by a layer of adhesive, the sealing member consists essentially of the fibrous scrim layer and the melt flow layer and the scrim layer substantially overlays an upper surface of the melt flow layer so that the melt flow layer impregnates a portion of the scrim, the polymeric melt flow layer is free to flow throughout the roof ditch without physical constraint from a structure of the sealing member, the sealing body has a rectangular profile.

In a further aspect, the present invention contemplates a method for sealing a roof ditch joint in an automotive vehicle, comprising the steps of: providing a sealing member that includes a polymeric melt flow layer wherein the melt flow layer includes an epoxy resin, an epoxy/elastomer adduct, a rheology modifier, a curing agent and a filler; and a woven polyester scrim layer attached to the melt flow layer wherein the scrim layer is located on a non horizontal surface and the scrim layer substantially overlays an upper surface of the melt flow layer so that the melt flow layer impregnates a portion of the scrim; and an adhesively attached fastener that receives and fastens an exterior trim molding to the sealing member, wherein the fastener is an elongated clip with a base portion and flexible members that extend upward from the base and the flexible members elastically deform during fastening to a trim piece; positioning the sealing member in a roof ditch over a joint defined by two overlapping metal sheets; coating the sealing member and the metal sheets; heating the coated metal sheets and the sealing member in a bake oven for causing the melt flow layer to flow and spread within the roof ditch and seal the joint, wherein the fibrous scrim layer maintains the location of the fastener substantially the same during exposure of the melt flow layer to elevated temperature, but the melt flow layer is free to flow throughout the roof ditch without physical constraint from a structure of the sealing member and attaching an exterior trim molding to the sealing member with the fastener to substantially cover the roof ditch.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of an exemplary sealant material according to an aspect of the present invention.

FIG. 1A is a sectional view of the exemplary sealant material of FIG. 1 applied to a substrate prior to activation of the sealant material according to an aspect of the present invention.

FIG. 1B is a sectional view of the exemplary sealant material of FIG. 1 applied to a substrate after activation of the sealant material according to an aspect of the present invention.

FIG. 2 is a perspective view of another exemplary sealant material according to an aspect of the present invention.

FIG. 2A is a sectional view of the exemplary sealant material of FIG. 2 applied to a substrate prior to activation of the sealant material according to an aspect of the present invention.

FIG. 2B is a sectional view of the exemplary sealant material of FIG. 2 applied to a substrate after activation of the sealant material according to an aspect of the present invention.

FIG. 3 is a perspective view of an exemplary sealant material supporting an exemplary component of an article of manufacture according to an aspect of the present invention.

FIG. 4 is a side view of an automotive vehicle having an exemplary sealant material according an aspect of the present invention.

### DETAILED DESCRIPTION OF THE PREFERRED EMBODIMENT

The present invention is predicated upon the provision of an improved sealant material and articles incorporating the same. The sealant material may include any combination of formulation improvements or design improvements disclosed herein. For example, and without limitation, the sealant material may include: a hardened surface; a tailored surface energy; a layer of blocking material; two or more portions of different material; one or more waxes; a tailored curing rate; particular positioning of the sealant material; masses for blocking bubbles; a coating, multiple layers combinations thereof, the like or others. As another example, the sealant material may be part of an assembly that is to be assembled to an article of manufacture.

The sealant material typically includes a melt flowable portion formed of a melt flowable material. As used herein, melt flowable is intended to mean that the portion or material, when exposed to an elevated temperature, softens, melts or both, to a degree sufficient for the material to flow enough to at least assist in sealing an opening (e.g., a hole, a cavity, a gap or the like). In use, the sealant material can be employed to at least partially support a component of an article of manufacture. When so used, the sealant material can include a mechanism or portion for maintaining that component of the article at a desired location relative to other components of the article of manufacture during melt flow of the melt flowable portion.

Examples of other sealant materials including physical designs of sealant materials and formulations of sealant materials, both of which may be used in conjunction with or as part of the sealant material of the present invention, are disclosed in the following references: U.S. Pat. No. 6,350,791; U.S. Pat. No. 6,489,023; U.S. Pat. No. 6,720,387; U.S. Pat. No. 6,742,258; U.S. Pat. No. 6,747,074; US 2004/0033324; US 2004/0016564; US 2005/0269840; US 2005/0221046; US 2006/0020076 WO 02/086003; WO 03/103921; WO 03/072677; WO 03/011954; WO 2004/037509; EP 0 742 814 B1; and EP 1 240 266 B1; all of which are incorporated herein by reference for all purposes.

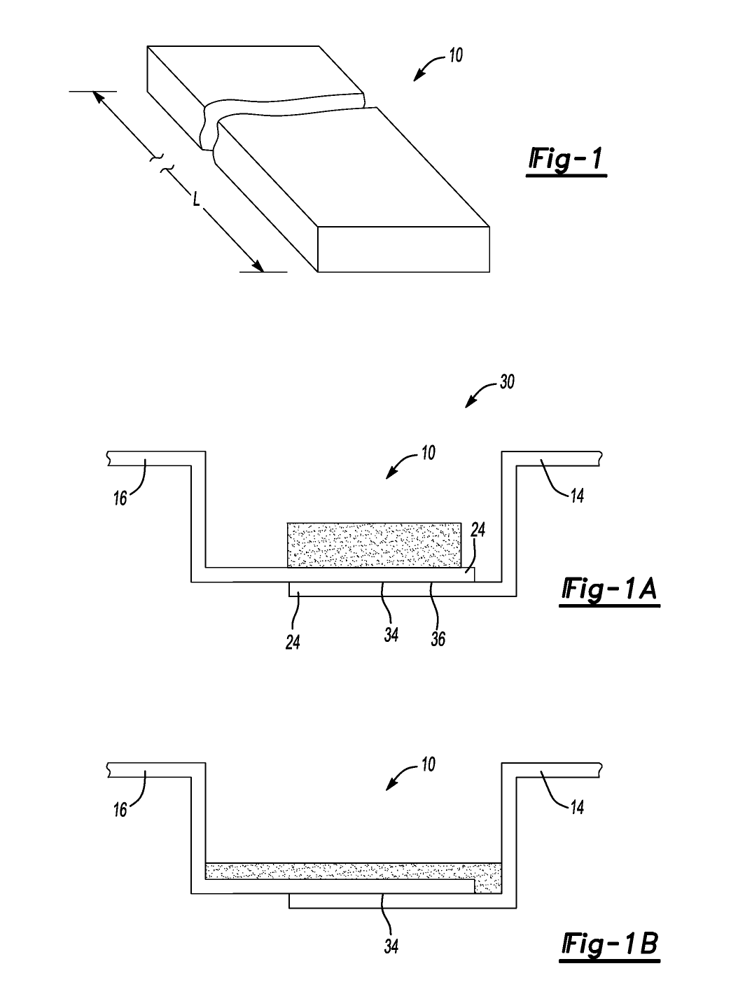

Referring to FIG. 1, there is illustrated one exemplary basic design of a sealant material 10 that may have an improved formulation according to the present invention. Of course, it should be understood that the formulations disclosed herein may be used in any of the physical designs of any sealant material disclosed herein or any other sealant material.

It is generally contemplated that, the sealant material may be formed in a variety of shapes or configurations. In the embodiment illustrated in FIG. 1, the sealant material 10 is an elongated strip that extends along a length (L) and has a rectangular cross-section perpendicular to that length (L). The sealant material 10 is formed entirely of an initially melt flowable material.

The sealant material may be used to cover, seal, reinforce, provide acoustic damping or the like to a variety of members or components of a variety of articles of manufacture. In the embodiment illustrated in FIGS. 1A and 1B, the sealant material 10 is placed within an opening 30 (e.g., a cavity, ditch or recess) that is formed by panels 14, 16. In the particular embodiment illustrated, the opening 30 is a roof ditch of an automotive vehicle that is typically formed from body panels of the vehicle. As shown, the overlapping ends 24 of the panels 14, 16 at least partially define the opening 30 and the overlapping ends 24 form an interface 34 between the two panels 14, 16. Typically, the interface 34 will define one or more gaps 36 between the overlapping ends 24 of the panels 14, 16, even though effort is typically expended to minimize such gaps 36 for articles of manufacture such as automotive vehicles. In the embodiment shown, the sealant material 10 overlays the interface 34.

### Initially Melt Flowable Material

While the sealant material 10 of FIGS. 1-1B is formed substantially entirely of initially melt flowable material, it will be understood that the initially melt flowable material described herein can be used for any of the sealant materials described herein (e.g., whether the initially melt flowable material is provided as a melt flow portion, layer or otherwise). It will also be understood that the function of the initially melt flowable material as described herein can be used to describe the function of the melt flow portion or layer of any of the sealant materials discussed herein. It should be understood that the initially melt flowable material of the present invention initially possesses thermoplastic material or properties, but can be subjected to curing or cross-linking and can thermoset upon exposure to heat as well such that the material loses its melt flow character. In this instance, the initially melt flowable material is different from a traditional melt flow material that is substantially entirely thermoplastic in nature and can be heated to flow and then reheated to flow a second time.

The initially melt flowable material is typically configured to activate upon exposure to a stimulus such as heat or possibly others. Upon activation, the sealant material typically softens, melts, cures, possibly expands, a combination thereof or the like. In FIG. 1 B, the expandable material 10 has been activated to soften and/or melt such that it flows and whets the substrate or the panels 14, 16 about the interface 34 thereby sealing the interface 34, the gap 36 or both formed by the panels 14, 16.

Generally, it is contemplated that a variety of materials can be employed in the sealant material. Thus, the preferred materials discussed herein should not be considered limiting unless otherwise stated.

### Epoxy Materials

Epoxy materials can be particularly suitable for the initially melt flowable material of the present invention. Epoxy resin is used herein to mean any of the conventional dimeric, oligomeric or polymeric epoxy materials containing at least one epoxy functional group. The polymer based materials may be epoxy containing materials having one or more oxirane rings polymerizable by a ring opening reaction. In preferred embodiments, the initially melt flowable material includes up to about 80% of an epoxy resin. More typically, the initially melt flowable material includes between about 2% and 50%, more typically between about 4% and about 20% and even more preferably between about 6% and about 10% by weight of epoxy containing materials, which can include polymers, resins, combinations thereof or the like.

The epoxy containing materials may be aliphatic, cycloaliphatic, aromatic or the like. The epoxy may be supplied as a solid (e.g., as pellets, chunks, pieces or the like) or a liquid (e.g., an epoxy resin) or both. The epoxy may be blended with one or more ethylene copolymers or terpolymers that may possess an alpha-olefin. As a copolymer or terpolymer, the polymer is composed of two or more different monomers, i.e., small chemically reactive molecules that are capable of linking up with each other or similar molecules. Preferably, an epoxy resin is added to the initially melt flowable material to increase the flow and/or adhesive properties of the material. One exemplary epoxy resin may be a phenolic resin, which may be a novalac type or other type resin. Other preferred epoxy containing materials may include a bisphenol-A epichlorohydrin ether polymer, or a bisphenol-A epoxy resin which may be modified with an additive.

### Epoxy/Elastomer

One or more of the epoxy containing materials may be provided to the initially melt flowable material as an epoxy/elastomer hybrid, e.g., a blend, copolymer or adduct that has been previously fabricated. The epoxy/elastomer hybrid, if included, may be included in an amount of up to about 90% by weight of the initially melt flowable material. Typically, the epoxy/elastomer hybrid is approximately 1 to 50% and more typically is approximately 5 to 20% by weight of the initially melt flowable material.

In turn, the hybrid itself generally includes about 1:5 to 5:1 parts of epoxy to elastomer, and more preferably about 1:3 to 3:1 parts or epoxy to elastomer. In one preferred embodiment, the epoxy/elastomer hybrid preferably includes approximately 40 to 80% of an epoxy resin (such as disclosed in the above), and about 20 to 60% of an elastomer compound. The elastomer compound may be a thermoplastic elastomer, thermosetting elastomer or a mixture thereof or otherwise. Exemplary elastomers include, without limitation natural rubber, styrenebutadiene rubber, polyisoprene, polyisobutylene, polybutadiene, isoprene-butadiene copolymer, neoprene, nitrile rubber, butyl rubber, polysulfide elastomer, acrylic elastomer, acrylonitrile elastomers, silicone rubber, polysiloxanes, polyester rubber, diisocyanate-linked condensation elastomer, EPDM (ethylene propylene diene rubbers), chlorosulphonated polyethylene, fluorinated hydrocarbons and the like. In one embodiment, recycled tire rubber is employed.

The epoxy/elastomer hybrid, when added to the initially melt flowable material, preferably is added to modify structural properties of the sealant material such as strength, toughness, stiffness, flexural modulus, or the like. Additionally, the epoxy/elastomer hybrid may be selected to render the initially melt flowable material more compatible with coatings such as water-borne paint or primer system or other conventional coatings.

### Elastomer

Rubber or elastomer may also be added to the initially melt flowable material as a separate ingredient. Again, the elastomer compound may be a thermoplastic elastomer, thermosetting elastomer or a mixture thereof or otherwise. Exemplary elastomers include, without limitation, natural rubber, styrenebutadiene rubber, polyisoprene, polyisobutylene, polybutadiene, isoprene-butadiene copolymer, neoprene, nitrile rubber, butyl rubber, polysulfide elastomer, acrylic elastomer, acrylonitrile elastomers, silicone rubber, polysiloxanes, polyester rubber, diisocyanate-linked condensation elastomer, EPDM (ethylene propylene diene rubbers), chlorosulphonated polyethylene, fluorinated hydrocarbons and the like. In one embodiment, recycled tire rubber is employed.

In one preferred embodiment, elastomer or rubber, whether added as part of a hybrid or adduct or on its own, is a substantial portion of the initially melt flowable material. The elastomer or rubber can be at least 10%, more typically at least 20% and possibly at least 35% or at least 55% by weight of the initially melt flowable material.

### Additional Polymers

Several different polymers may be incorporated into the initially melt flowable material, e.g., by copolymerization, by blending, or otherwise. For example, without limitation, other polymers that might be appropriately incorporated into the initially melt flowable material include halogenated polymers, polycarbonates, polyketones, urethanes, polyesters, silanes, sulfones, allyls, olefins, styrenes, acetates, ethylene vinyl acetates, acrylates, methacrylates, epoxies, silicones, phenolics, rubbers, polyphenylene oxides, terphthalates, or mixtures thereof. Other potential polymeric materials may be or may include include, without limitation, polyethylene, polypropylene, polystyrene, polyolefin, polyacrylate, poly(ethylene oxide), poly(ethyleneimine), polyester, polyurethane, polysiloxane, polyether, polyphosphazine, polyamide, polyimide, polyisobutylene, polyacrylonitrile, poly(vinyl chloride), poly(methylmethacrylate), poly(vinyl acetate), poly(vinylidene chloride), polytetrafluoroethylene, polyisoprene, polyacrylamide, polyacrylic acid, polymethacrylate, and polyacetals. Generally, such polymers can be from about 1% to about 90% of the initially melt flowable material.

In one preferred embodiment, the initially melt flowable material includes acrylate copolymer, acetate copolymer or both. In one preferred embodiment, the initially melt flowable material includes ethylene methacrylate (EMA), ethylene vinyl acetate (EVA) or a combination thereof. When included, EMA is typically between about 1% and about 70%, more typically between about 30% and about 60% and even more typically between about 44% and about 55% by weight of the initially melt flowable material. A desirable EMA can have a melt index between about 110 and about 150 grams/10 min. (e.g., about 135 grams/10 min.). One preferred EMA is sold under the tradename TC140 and is commercially available from Exxon. When included, EVA is typically between about 1% and about 70%, more typically between about 2% and about 10% and even more typically between about 3% and about 5% by weight of the initially melt flowable material.

It is also contemplated that the sealant mateiral can include one or more isocyanate reactive ingredients (e.g., polyols), which can be reactive with blocked isocyanates. Example of such ingredients and isocyanates are disclosed in U.S. Patent Application, Publication No. 2005/0320027, which is incorporated herein by reference for all purposes.

### Rheology Modifier

The initially melt flowable material can also include one or more materials for controlling the rheological characteristics of the material over a range of temperatures (e.g., up to about 250° C. or greater).

In one embodiment, any suitable art-disclosed rheology modifier may be used, and thus the rheology modifier may be organic or inorganic, liquid or solid, or otherwise. In one preferred embodiment, the rheology modifier is a polymer, and more preferably one based upon an olefinic (e.g., an ethylene, a butylenes, a propylene or the like), a styrenic (e.g., a styrene-butadiene-containing rubber), an acrylic or an unsaturated carboxylic acid or its ester. The rheology modifier may be provided in a generally homogeneous state or suitable compounded with other ingredients. It is also contemplated that the various clays, minerals or other materials discussed in relation to fillers below can be employed to modify rheology of the initially melt flowable material.

### Blowing Agent

Optionally, one or more blowing agents may be added to the initially melt flowable material, although for some applications the initially melt flowable material will be substantially or entirely devoid of blowing agent or blowing agent accelerator. When used, the blowing agent typically produces inert gasses that form as desired an open and/or closed cellular structure within the initially melt flowable material. In this manner, it may be possible to lower the density of articles fabricated from the material. In addition, the material expansion can help to improve sealing or wetting capability.

The blowing agent may include one or more nitrogen containing groups such as amides, amines and the like. Examples of suitable blowing agents include azodicarbonamide, dinitrosopentamethylenetetramine, azodicarbonamide, dinitrosopentamethylenetetramine, 4,4ᵢoxy-bis-(benzenesulphonylhydrazide), trihydrazinotriazine and N, Nᵢ-dimethyl-N,Nᵢdinitrosoterephthalamide. In a one embodiment, modified and unmodified azocarbonamides may be supplied to the material 10 in particle form having particles sizes of, for example, 120 and 180 microns. Advantageously, the azocarbonamides can assist the initially melt flowable material in leveling itself (i.e., forming a surface of maintaining the surface 24 in a substantially flat condition).

An accelerator for the blowing agents may also be provided in the initially melt flowable material. Various accelerators may be used to increase the rate at which the blowing agents form inert gasses. One preferred blowing agent accelerator is a metal salt, or is an oxide, e.g. a metal oxide, such as zinc oxide.

Amounts of blowing agents and blowing agent accelerators can vary widely within the initially melt flowable material depending upon the type of cellular structure desired, the desired amount of expansion of the initially melt flowable material, the desired rate of expansion and the like. Exemplary ranges for the amounts of blowing agents and blowing agent accelerators in the initially melt flowable material range from about 0% by weight to about 5% by weight and are preferably in the initially melt flowable material in fractions of weight percentages.

### Curing Agent

One or more curing agents and/or curing agent accelerators may be added to

the initially melt flowable material. Amounts of curing agents and curing agent accelerators can, like the blowing agents, vary widely within the initially melt flowable material depending upon the type of cellular structure desired, the desired amount of expansion of the initially melt flowable material, the desired rate of expansion, the desired structural properties of the initially melt flowable material and the like. Exemplary ranges for the curing agents, curing agent accelerators or both present in the initially melt flowable material range from about 0% by weight to about 7% by weight.

Preferably, the curing agents assist the initially melt flowable material in curing by crosslinking of the polymers, epoxy resins or both. It is also preferable for the curing agents to assist in thermosetting the initially melt flowable material. Useful classes of curing agents are materials selected from aliphatic or aromatic amines or their respective adducts, amidoamines, polyamides, cycloaliphatic amines (e.g., anhydrides, polycarboxylic polyesters, isocyanates, phenol-based resins (such as phenol or cresol novolak resins, copolymers such as those of phenol terpene, polyvinyl phenol, or bisphenol-A formaldehyde copolymers, bishydroxyphenyl alkanes or the like), or mixtures thereof. Particular preferred curing agents include modified and unmodified polyamines such as triethylenetetramine, diethylenetriamine tetraethylenepentamine, cyanoguanidine and the like. An accelerator for the curing agents (e.g., methylene diphenyl bis urea) may also be provided for preparing the initially melt flowable material.

Other preferred curing agents can include peroxides, such as bis(t-butylperoxy)diisopropylbenzene, 1,1-di-t-butylperoxy-3,3,5-trimethylcyclohexane, 4,4-di-t-butylperoxy n-butyl valerate, dicumyl peroxide, and the like.

It can also be desirable for one or more of the curing agents to be higher temperature curing agents. Such a curing agent is typically configured to cure and or crosslink polymers of the initially melt flowable material at a temperature that is at least 120° C., more typically at least 170° C. and possibly at least 200° C.

### Filler

The initially melt flowable material may also include one or more fillers, including but not limited to particulated materials (e.g., powder), beads, microspheres, or the like. Preferably the filled includes a relatively low-density material that is generally nonreactive with the other components present in the initially melt flowable material.

Examples of fillers include silica, diatomaceous earth, glass, clay, talc, pigments, colorants, glass beads or bubbles, glass, carbon ceramic fibers, antioxidants, and the like. Such fillers, particularly clays, can assist the initially melt flowable material in leveling itself during flow of the material. The clays that may be used as fillers may include clays from the kaolinite, illite, chloritem, smecitite or sepiolite groups. Examples of suitable fillers include, without limitation, talc, vermiculite, pyrophyllite, sauconite, saponite, nontronite, montmorillonite or mixtures thereof. The clays may also include minor amounts of other ingredients such as carbonates, feldspars, micas and quartz. The fillers may also include ammonium chlorides such as dimethyl ammonium chloride and dimethyl benzyl ammonium chloride. Titanium dioxide might also be employed.

In one preferred embodiment, one or more mineral or stone type fillers such as calcium carbonate, sodium carbonate or the like may be used as fillers. In another preferred embodiment, silicate minerals such as mica may be used as fillers. It has been found that, in addition to performing the normal functions of a filler, silicate minerals and mica in particular can assist in leveling the initially melt flowable material.

When employed, the fillers in the initially melt flowable material can range from 10% to 90% by weight of the initially melt flowable material. According to some embodiments, the initially melt flowable material may include from about 0% to about 3% by weight, and more preferably slightly less that 1% by weight clays or similar fillers. Powdered (e.g. about 0.01 to about 50, and more preferably about 1 to 25 micron mean particle diameter) mineral type filler can comprise between about 5% and 70% by weight, more preferably about 40% to about 60%, and still more preferably approximately 55% by weight of the initially melt flowable material. In one highly preferred embodiment the initially melt flowable material may contain approximately 7% by weight mica.

### Other Additives

Other additives, agents or performance modifiers may also be included in the initially melt flowable material as desired, including but not limited to a UV resistant agent, a flame retardant, an impact modifier, an adhesion promoter, a heat stabilizer, a colorant, a processing aid, a lubricant, a reinforcement (e.g., chopped or continuous glass, ceramic, aramid, or carbon fiber or the like). One preferred additive is an adhesion promoter such as a hydrocarbon resin. Another preferred additive is a coagent such an acrylate coagent.

Once formed, the sealant material typically has a melt temperature less than about 200° C., more typically less than about 140° C. and even more typically less than about 100° C., but typically greater than about 30° C., more typically greater than about 50° C. and even more typically greater than about 65° C., although higher or lower melt temperatures are possible depending upon the manner of application of the sealant material. The sealant material also typically has a glass transition temperature that is less than about 20° C., more typically less than about −5° C. and even more typically less than about −25° C., but typically greater than about −100° C., more typically greater than about −60° C. and even more typically greater than about −40° C., although higher or lower glass transition temperatures are possible depending upon the manner of application of the sealant material

Table A below provides an exemplary initially melt flowable material according to the present invention.

TABLE A

| Ingredient | Wt. Percent |
|---|---|
| EMA | 47.9 |
| EVA Resin | 4 |
| Solid Epoxy Resin | 8.6 |
| Adhesion Promoter (Aliphatic Hydrocarbon | 5 |
| Resin) | |
| Calcium Carbonate Filler | 31.94 |
| High Temperature Peroxy Curing Agent | 0.3 |
| Carbon Black | 0.1 |
| Cyanoquanidine Curing Agent | 0.02 |
| Trifunctional Acrylate Coagent (ethoxylated | 2.14 |
| bisphenol A diacrylate) | |

Since the initially melt flowable material of Table A is merely exemplary, it is contemplated that the weight percents of the various ingredients may vary by ±50% or more or by ±30% or ±10%. For example, a value of 50±10% is a range of 45 to 55. Moreover, ingredients may be added or removed from the formulation.

### Formation

The sealant material and particularly the melt flow portion or layer of the sealant material of the present invention may be formed using several different techniques. Preferably, the initially melt flowable material or at least a portion thereof has a substantially homogeneous composition within itself. However, it is contemplated that various combining techniques may be used to increase or decrease the concentration of certain components in certain locations of the portions of the initially melt flowable material or the initially melt flowable material itself.

According to one embodiment, the initially melt flowable material can be formed by supplying the components of the material in solid form such as pellets, chunks and the like, in liquid form or a combination thereof. The components are typically combined in one or more containers such as large bins or other containers. Preferably, the containers can be used to intermix the components by rotating or otherwise moving the container. Thereafter, heat, pressure or a combination thereof may be applied to soften or liquidize the components such that the components can be intermixed by stirring or otherwise into a single homogenous composition.

According to another embodiment, the materials of the sealant material may be processed by heating one or more of the components that is generally easier to soften or liquidize such as the polymer based materials to induce those components into a mixable state. Thereafter, the remaining components may then be intermixed with the softened components.

For mixing, a variety of mixers or other devices may be employed. For example, such devices can include, without limitation, an internal mixer, a kneader, a mill, a single or twin screw extruder, a planetary mixer, a compounding extruder, combinations thereof or the like.

In one preferred embodiment, the sealant is substantially free of an ethylene monomer and is also substantially free of an adhesive tape or adhesive film. In another preferred embodiment, the sealant material is substantially free of a photo-polymerizable material or a polymerizable vinyl material and is also substantially free of a polyurethane component, a dimensionally stable film and a cap.

### Locator Mechanism

As suggested, the sealant material of the present invention can include a mechanism for assisting in locating at least one first component of an article of manufacture relative to at least one second component of the article. This is the case particularly where the at least one first component at least partially relies on the sealant material, particularly the initially melt flowable material or portion, for support and where that support is at least partially lost during flow of the melt flow material or portion or lost during subsequent heat and/or softening of the material subsequent to flow and cure of the material.

Such a locator mechanism can include one or more members, which are integral with the at least one first component and which extend to and contact (e.g., attach to by fastening, adhering or otherwise) the at least one second component for spatially substantially maintaining the at least one first component at a similar or substantially same location relative to the at least one second component during activation and flow of the initially melt flowable material and/or during softening of the material subsequent to flow and cure of the material. Such locator mechanism can additionally or alternatively include one or more members, which are integral with the at least one second component and which extend to and contact (e.g., attach to by fastening, adhering or otherwise) the at least one first component for spatially substantially maintaining the at least one first component at a similar or substantially same location relative to the at least one second component during activation and flow of the initially melt flowable material and/or during softening of the material subsequent to flow and cure of the material.

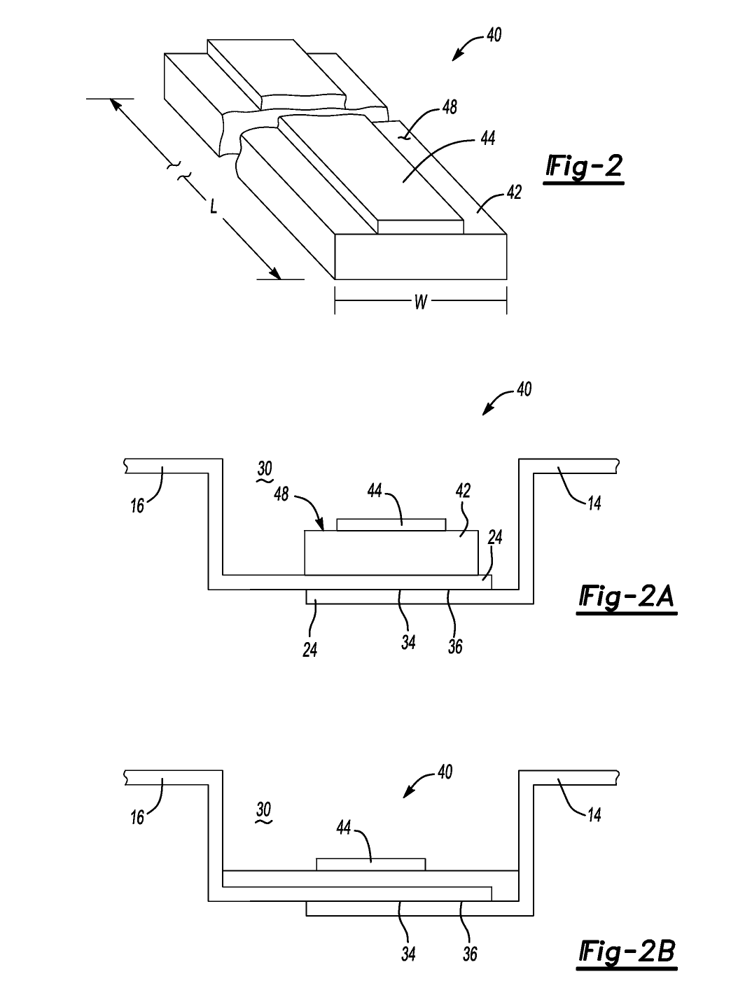

In one desirable embodiment and with reference to FIG. 2, it is contemplated that a sealant material 40 according to the present invention can comprise one or more portions or layers 42 of initially melt flowable material and a locator mechanism shown as one or more layers 44 of secondary material. The layer 44 of secondary material typically overlays a surface 48 (e.g., an upper surface) of the layer 42 of initially melt flowable material although not required unless otherwise specifically stated. Advantageously, the layer 42 of secondary material can act as a locator mechanism for generally fixing the location of one component of an article of manufacture in a substantially similar location to one or more other components of the article of manufacture as is described further herein.

The layer 44 of secondary material can extend along substantially the entire length (L) of the layer 42 of initially melt flowable material or can extend along less than three quarters, less than one half or even less than one quarter of the length (L) of the initially melt flowable material. Moreover, the layer 44 of secondary material can be continuous along the length (L) of the layer 42 of the initially melt flowable material or the layer 44 of secondary material can comprise multiples separate strips distributed along the length (L) of the initially melt flowable material (e.g., with one strip extending from adjacent a first end of the layer 42 and a second strip extends from adjacent a second opposite end of the layer 42).

While it is possible that the layer 44 of secondary material can span the entire or substantially the entire width (W) of the surface 48 and/or the layer 42 of initially melt flowable material, it is also possible that the layer 44 of secondary material span only part of the width (W) of the surface 48 and/or layer 42. In particular, the layer 44 of secondary material can be configured to span less than 90%, less than 80% or even possibly less than 70% or even 60% of the width (W) of the surface 48 and/or the layer 42 of initially melt flowable material.

The secondary material for the layer 44 of secondary material can be formed of a variety of different materials and can be formed of one singular material or plural materials. Without limitation, it is contemplated that the secondary material can be a metal foil, rubber sheets or films, woven rovings, mats, fabrics, fibrous materials, woven or unwoven fiberglass layers, combinations thereof or the like. In one embodiment, a scrim material is used to form the layer of secondary material. As an example, the scrim material can be a spunbonded polymeric (e.g., polyester) scrim. The scrim can be formed of fibers (e.g. glass or polymeric fibers) that can be woven, non-woven, a roving, an agglomeration or otherwise. The scrim can be provided as a single or multilayer composite with copolymer binder. When used, the scrim will typically be between about 1 and about 100 mils thick and more typically between about 5 and about 20 mils thick. It is also contemplated that the layer or portion of secondary material could be a formulated reinforcement material such as L5020, L5001, L8200 or L8201, commercially available from L&L Products, Romeo, Mich. Such a material could be co-extruded directly onto the the layer 42 of initially melt flowable material. It is also contemplated that elastomer or rubber may be a substantial portion of the secondary material. The elastomer or rubber may be one or any combination of the elastomers discussed in relation to the initially melt flowable material and, when used, can at least about 10%, more typically at least about 30% and still more typically at least about 55% by weight of the secondary material.

The layer 44 of secondary material can be disposed upon the surface 48 of the layer 42 of initially melt flowable material having predetermined dimensions (i.e., width and thickness). Alternatively, the layer 44 of secondary material can be disposed upon layer 42 of initially melt flowable material followed by cutting the layer 44 to desired dimension such as desired width such that the material spans the layer 42 of initially melt flowable material as described herein. The thickness of the layer 44 of secondary material can vary depending upon the material used and other factors, however, it is generally desirable for the thickness of the layer to be greater than 0.005 inch, more typically greater than about 0.008 inch and even more typically greater than about 0.01 inch. It is also contemplated that an adhesive can continuously or intermittently adhere the layer 44 of secondary material to the layer 44 of initially melt flowable material.

It is also contemplated that the layer of secondary material can be pressed into or located at least partially or more fully within the layer of initially melt flowable material. In such an embodiment, a mechanism such as rollers or otherwise may be employed to press the secondary material into the initially melt flowable material. As such the layer of secondary material may not be a distinct layer from initially melt flowable material by may form an interpenetrating network therewith. Thus, the layer of secondary material may penentrate the surface of the initially melt flowable material and the surface of the melt flowable material can be slight above the layer of secondary material.

It should be noted that the secondary material can be made of a single layer of one material, multiple layers of one material or multiple layers of multiple different materials.

### Application

The sealant material may be applied to a variety of substrates. However, for exemplary purposes and with no intention of limiting the invention, unless otherwise stated, the materials of FIGS. 1-3 are shown as applied to components 14, 16 (e.g., overlapping panels) for forming a joint. The joint, as shown, is formed with overlapping ends 24 of the two components 14, 16. In one embodiment, the substrate is formed of a material that includes metal (e.g., steel, aluminum, iron, tin, magnesium, a combination thereof or the like), plastic (e.g., reinforced plastic), a combination thereof or the like.

As discussed, the sealant materials 10, 40 may be formed in a variety of shapes, sizes, patterns, thicknesses or the like and may be formed using a variety of forming techniques such as molding, extruding, thermosetting and the like. It is also contemplated that the sealant material or one of the portions thereof may be initially formed in a substantially liquid state wherein the material is shaped by its container or shaped by a substrate to which the material has been applied.

The sealant material, particularly the melt flow portion or layer, may be dry to the touch shortly after it is initially formed to allow easier handling, packaging, application to a substrate and the like of the material, however, it is also possible for the material to be wet, tacky or both. As such, the sealant material may be placed adjacent a substrate either manually, automatically or semi-automatically. In one preferred embodiment, the sealant material is extruded directly onto the substrate that is to be sealed by the material. In another embodiment, the sealant material is manually applied as an insert.

In the embodiments illustrated in FIGS. 1-3, the sealant materials 10, 40 are placed or located within the opening 30 (e.g., a cavity, ditch or recess) that is formed by the panels 14, 16. In the particular embodiment illustrated, the opening 30 is a roof ditch of an automotive vehicle that is typically formed from body panels of the vehicle. As shown, the overlapping ends 24 of the panels 14, 16 at least partially define the opening 30 and the overlapping ends 24 form an interface 34 between the two panels 14, 16. Typically, the interface 34 will define one or more gaps 36 between the overlapping ends 24 of the panels 14, 16, even though effort is typically expended to minimize such gaps 36 for articles of manufacture such as automotive vehicles.

For sealing a substrate, the sealant material is typically placed upon the substrate adjacent to a target location that is to be sealed. Generally, it is contemplated that the target location of the substrate may be any type of opening of the substrate such as a cavity, a recess, a gap or the like or may be a flat or contoured portion of the substrate.

In FIGS. 1-3, the target location is the interface 34 and/or the one or more gaps 36 formed by the components 14,16 and/or the surface of the panels 14,16. As can be seen, the sealant materials 10, 40 are placed or located overlaying and/or adjacent the interface 34 and the one or more gaps 36 formed by the interface 34.

Once the sealant material has been formed in a desired configuration and located, as desired, relative to a substrate, the material may be activated to flow, expand, whet, seal, cure or any combination thereof to form a seal of a desired configuration. Activation of the sealant material, may take place in a single stage or multiple stages and may utilize a variety of stimuli to cause activation. Activation, as used herein, generally denotes inducing the sealant material to flow, generally soften, foam, expand, cure or a combination thereof and can be caused by exposure of the sealant material to a variety of stimuli such as heat, light, electricity, pressure, moisture and the like. Curing, as used herein, generally denotes any stiffening, hardening, solidifying or the like of the sealant material and can be caused by exposure to a variety of stimuli such as heat, cooling, light, moisture combinations thereof or the like.

According to one embodiment, the sealant material may be at least partially activated prior to application of the sealant material to a substrate such that the sealant material is in a generally flowable state when it is applied to the substrate. In such a situation, curing of the material may occur during or after the time the sealant material is applied to the substrate.

According to another embodiment, the sealant material may undergo a single stage activation, a single stage cure or both. According to still other embodiments, the sealant material may undergo a selective multiple stage activation, a multiple stage cure or both. For example, a portion of the sealant material may be exposed to a stimulus to at least partially cure a portion of the sealant material, e.g. a cure to a predetermined depth (e.g., on the order of about 1 mil to about 2 mm), or a cure in certain regions along or within the mass of material.

Upon activation, typically caused by exposure to heat or other stimulus, the melt flowable portion of the sealant material becomes flowable. This allows the melt flowable portion to flow over and seal the target location of the substrate. Generally, the layer 44 of secondary material does not control the melt flow behavior of the melt flow layer 42 and does not substantially confine the layer of melt flow material to any particular area of the surface of a substrate during flow. Preferably and advantageously, the formulation or other characteristics of the initially melt flowable material allows the layer 42 of initially melt flowable material to flow over and seal the substrates or surfaces and/or interface 34 as shown in FIGS. 2A and 2B without the layer 44 of secondary material being needed or desired to confine the layer 42 of melt flow material during flow thereof. This can be the case when, as shown, the layer 44 of secondary material spans only part of the width (W) of the surface 48 and/or layer 42 of initially melt flowable material or when the secondary material spans the entire width (W). Moreover, the layer 44 of secondary material need not necessarily be dimensionally stable or can at least be less dimensionally stable if it does not need to confine the layer of initially melt flowable material. The layer 44 can be relatively flexible, bendable and/or, at least to some degree, stretchable so long as it performs its desired functions. This allows the layer 44 to be made of materials other than films, those materials being discussed above.

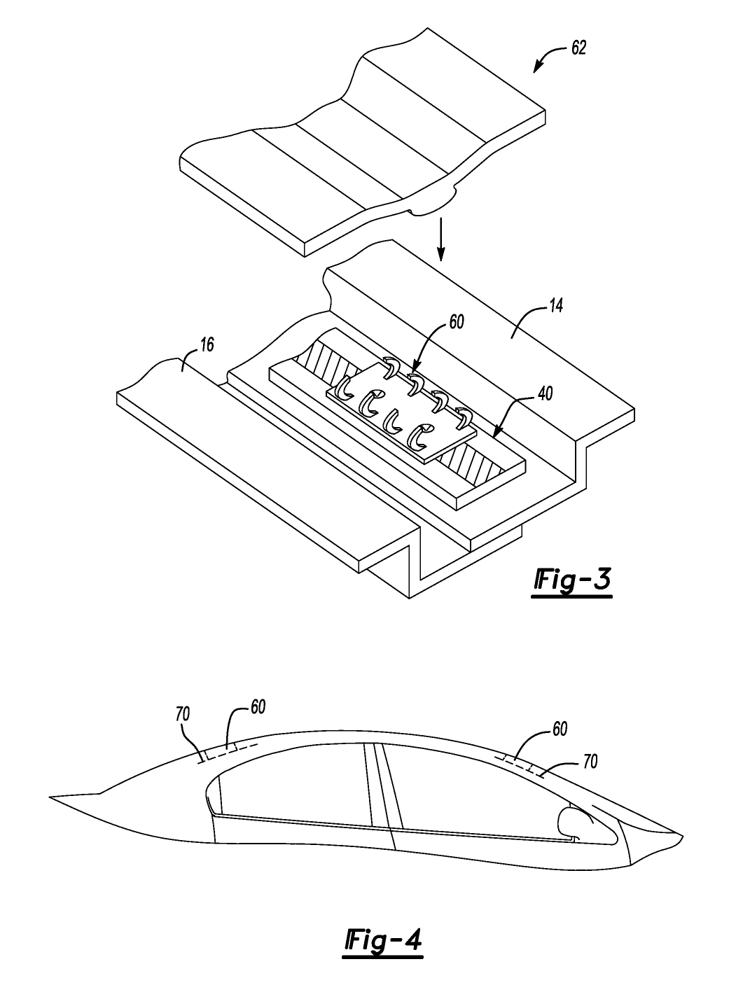

As one desirable example, FIG. 3 shows the sealant material 40 of FIGS. 2A and 2B with a first component or member 60 disposed upon and supported by by sealant material 40. The particular component or member 60 shown is a fastener that is designed as an elongated clip for receiving and fastening to another component 62 (e.g., a vehicle trim component) of an automotive vehicle. The fastener may be adhesively attached to the sealant material. In one preferred embodiment, the fastener has a base and projecting members which project upward from the base and terminate as free ends that are spread apart from each other. The proejecting members may be elastically deformable to allow for temporary flexing during fastening to another component. As can be seen, the component 62 is attached to the layer 42 of initially melt flowable material, the layer 44 of secondary material or both. Such attachment can be accomplished with attachments such as mechanical fasteners, adhesives or the like. Moreover, such attachment can be before the initial flow and/or cure of the melt flow material or after the flow and/or cure of the initially melt flowable material Advantageously, contact or attachment between the layer 44 of secondary material and the component 60 maintains or at least assists in maintaining the component 60 in a substantially same or similar location relative to the other second component[s] 14, 16 of the article (e.g., the vehicle) during melt flow of the layer 42 of initially melt flowable material or during subsequent softening of the initially melt flowable material after flow and/or cure of the material. Such subsequent softening can occur where, for example, the initially melt flowable material flows, seals and cures in an automotive primer oven after e-coat and then the secondary material prohibits or limits movement of the components as described above during subsequent heating and softening (e.g., non-flow softening) of the initially melt flowable material during exposure to heat in the automotive base coat or paint oven.

As used herein, the phrase suggesting maintenance of a substantially same or similar location means that that the first component that is at least partially supported by the initially melt flowable material moves less than 5 centimeters, more typically less than 3 centimeters, still more typically less than 1 centimeter and even still more typically less that 5 millimeters and even possibly less than 3 millimeters or even 1 millimeter relative to the other one or more second components.

This function of the locator mechanism, which as shown is the layer 44 of secondary material, is particularly advantageous for situations in which gravitational forces or other forces would otherwise move the component 60 during flow of the layer 42 of initially melt flowable material. For example, with reference to an example in FIG. 4, the sealant material 40, the component[s] or both may be located upon substantially non-horizontal surface[s] 70, 72 such that gravity would tend to move the component[s] 60 along the surface[s] 70, 72 absent the locator mechanism during flow of the initially melt flowable material or during subsequent softening of the material after flow. Non-horizontal typically means at an angle of at least 5 degrees, more typically at least 15 degrees and even more typically at least 30 degrees relative to horizontal. In FIG. 4, the exemplary non-horizontal surface[s] 70, 72 are like those shown in FIGS. 1-3 and are for a roof ditch of an automotive vehicle and are located adjacent a windshield and/or A-pillar of a vehicle or, alternatively, adjacent a backlite and/or B, C, or D-pillar of a vehicle. Of course, these surfaces could be from other articles of manufacture or other vehicle locations.

Additionally or alternatively, it is contemplated that a sealed joint prepared in accordance with the present invention can be further coated with a top coat (e.g., a paint) and optionally a primer (between the top coat and the joint), a clear coat (e.g., a polyurethane, an acrylic such as a glycidyl methacrylate (GMA)-based coating, or a mixture thereof) over the top coat, or a combination thereof. Preferably one such coating is a water-based coating, although solvent based coatings may also be used. In one embodiment, the coating includes a two component polyurethane coating. In another embodiment the coating is applied as a powder coating. Preferably an electrocoating process is used to apply a coating layer, such as an e-coat or other layer.

When used in automotive applications (e.g., in a roof ditch), the sealant material may be applied to the vehicle after exposure of the vehicle to the electrocoat bake oven but prior to exposure of the vehicle to the paint bake oven. In such an embodiment, the sealant material will typically be configure to melt, soften, cure or a combination thereof in the paint bake oven. The sealant material may also be applied after the paint bake oven and be configured to cure in separate operation. However, for a higher temperature curing material, it is preferable for the sealant material to be applied prior to exposure of the vehicle to the electrocoat oven and for the sealant material to be configure to soften, melt, cure of a combination thereof in the electrocoat oven.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied in order to determine the true scope and content of the invention.

What is claimed is:

1. A method for sealing a roof ditch joint in an automotive vehicle, comprising the steps of:
a) providing a sealing member that includes
i) a polymeric melt flow layer; and
ii) a fibrous scrim layer attached to the melt flow layer; and
ii) a fastener that receives and fastens an exterior trim molding to the sealing member;
b) positioning the sealing member in a roof ditch over a joint defined by two overlapping metal sheets;
c) coating the sealing member and the metal sheets;
d) heating the coated metal sheets and the sealing member in a bake oven for causing the melt flow layer to flow and spread within the roof ditch and seal the joint;
e) attaching an exterior trim molding to the sealing member with the fastener to substantially cover the roof ditch.

2. A method as in claim 1 wherein the fibrous scrim layer is a woven fibrous scrim layer.

3. A method as in claim 2 wherein the woven fibrous scrim layer includes polyester.

4. A method as in claim 2 wherein the fastener is an elongated clip with a base portion and flexible members that extend upward from the base and the flexible members elastically deform during fastening to a trim piece.

5. A method as in claim 3 wherein the fastener is an elongated clip with a base portion and flexible members that extend upward from the base and the flexible members elastically deform during fastening to a trim piece.

6. A method as in claim 2 wherein the fastener is attached to an upper surface of the sealing member by a layer of adhesive.

7. A method as in claim 2 wherein the sealing member consists essentially of the fibrous scrim layer and the melt flow layer and the scrim layer substantially overlays an upper surface of the melt flow layer so that the melt flow layer impregnates a portion of the scrim.

8. A method as in claim 5 wherein the sealing member consists essentially of the fibrous scrim layer and the melt flow layer and the scrim layer substantially overlays an upper surface of the melt flow layer so that the melt flow layer impregnates a portion of the scrim.

9. A method as in claim 2 wherein the polymeric melt flow layer is free to flow throughout the roof ditch without physical constraint from a structure of the sealing member.

10. A sealing member for sealing a roof ditch comprising:
a. an elongated substantially constant profile sealing body including:
i) a polymeric melt flow layer; and
ii) a fibrous scrim layer attached to the melt flow layer;
b. fasteners that project away from an upper surface of the sealing body and receive an exterior trim molding.

11. A sealing member as in claim 10 wherein the fibrous scrim layer is a woven fibrous scrim layer.

12. A sealing member as in claim 11 wherein the woven fibrous scrim layer includes polyester.

13. A sealing member as in claim 11 wherein the fastener is an elongated clip with a base portion and flexible members that extend upward from the base and the flexible members elastically deform during fastening to a trim piece.

14. A sealing member as in claim 12 wherein the fastener is an elongated clip with a base portion and flexible members that extend upward from the base and the flexible members elastically deform during fastening to a trim piece.

15. A sealing member as in claim 11 wherein the fastener is attached to an upper surface of the sealing member by a layer of adhesive.

16. A sealing member as in claim 11 wherein the sealing member consists essentially of the fibrous scrim layer and the melt flow layer and the scrim layer substantially overlays an upper surface of the melt flow layer so that the melt flow layer impregnates a portion of the scrim.

17. A sealing member as in claim 14 wherein the sealing member consists essentially of the fibrous scrim layer and the melt flow layer and the scrim layer substantially overlays an upper surface of the melt flow layer so that the melt flow layer impregnates a portion of the scrim.

18. A sealing member as in claim 11 wherein the polymeric melt flow layer is free to flow throughout the roof ditch without physical constraint from a structure of the sealing member.

19. A sealing member as in claim 11 wherein the sealing body has a rectangular profile.

20. A method for sealing a roof ditch joint in an automotive vehicle, comprising the steps of:
a. providing a sealing member that includes
i) a polymeric melt flow layer wherein the melt flow layer includes an epoxy resin, an epoxy/elastomer adduct, a rheology modifier, a curing agent and a filler; and
ii) a woven polyester scrim layer attached to the melt flow layer wherein the scrim layer is located on a non horizontal surface and the scrim layer substantially overlays an upper surface of the melt flow layer so that the melt flow layer impregnates a portion of the scrim; and
iii) an adhesively attached fastener that receives and fastens an exterior trim molding to the sealing member, wherein the fastener is an elongated clip with a base portion and flexible members that extend upward from the base and the flexible members elastically deform during fastening to a trim piece;
b. positioning the sealing member in a roof ditch over a joint defined by two overlapping metal sheets;
c. coating the sealing member and the metal sheets;
d. heating the coated metal sheets and the sealing member in a bake oven for causing the melt flow layer to flow and spread within the roof ditch and seal the joint, wherein the fibrous scrim layer maintains the location of the fastener substantially the same during exposure of the melt flow layer to elevated temperature, but the melt flow layer is free to flow throughout the roof ditch without physical constraint from a structure of the sealing member; and
e. attaching an exterior trim molding to the sealing member with the fastener to substantially cover the roof ditch.
